(19) United States
(12) Patent Application Publication
(10) Pub. No.: US 2008/0289327 A1
(43) Pub. Date: Nov. 27, 2008

(54) Linear Drive

(76) Inventors: Rolf Mintgen, Thuer (DE); Frank Born, Dienethal (DE); Rainer Massmann, Bonn (DE); Moritz Starkmeth, Koblenz (DE); Stefan Nissl, Pettendorf (DE); Robert Geiger, Metten-Berg (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/631,140

(22) PCT Filed: Oct. 7, 2005
(86) PCT No.: PCT/EP2005/010828

§ 371 Date: Dec. 28, 2006

(30) Foreign Application Priority Data
Oct. 8, 2004 (DE) 10 2004 049 433.9
Dec. 22, 2004 (DE) 10 2004 061 675.2
Aug. 17, 2005 (DE) 10 2005 038841.8

(51) Int. Cl. F16D 31/02

(52) U.S. Cl. 60/477

(57) ABSTRACT

The invention relates to a fluid linear drive having a cylinder (1) which is entirely or partially filled with a pressure medium. A piston (2) is arranged inside said cylinder so as to be displaced and has a piston rod (10) which is arranged at one end of the piston (2) and is led out of the cylinder (1) in a scaling manner. The piston subdivides the interior space of the cylinder into a first chamber (6) and a second chamber (7), the piston rod (10) extending through the second chamber (7). A pump (17), which is particularly reversible and by means of which the pressure medium can be pumped into the first chamber (6) and pumped off from the first chamber (6), has a first intake and/or pressure connection (18) and a second intake and/or pressure connection (19). The first intake and/or pressure connection of the pump (17) is connected to the first chamber (6) and the second intake and/or pressure connection is connected to a storage chamber. The pump (17) is mounted in the piston (2) or in or on a bottom of the first chamber.

The invention relates to a fluid linear drive with a cylinder which is filled completely or partially with a pressure medium and in which a piston, with a piston rod arranged on one side on the piston and led, sealed off, out of the cylinder, is arranged displaceably and subdivides the cylinder inner space into a first chamber and into a second chamber, the piston rod being led through the second chamber, and with an, in particular reversible, pump which has a first suction and/or delivery connection and a second suction and/or delivery connection and through which the pressure medium can be pumped into the first chamber and out of the first chamber.

Fluid linear drives of this type form active actuating elements and can be used for the automatic adjustment of flaps and doors or else for automatic height adjustment. Applications may be envisaged both in a motor vehicle and for height adjustment in furniture.

Furthermore, a linear drive for automatic doors is known, which has a piston rod which extends completely through a cylinder and on which a piston is arranged which subdivides the cylinder into cylinder halves. A pump is provided here for controlling a movement of the linear drive.

The object of the invention is to provide a fluid linear drive of the type initially mentioned, which, along with high efficiency in the step-up of force, is constructed in a simple way and requires a small construction space.

This object is achieved, according to the invention, in that the first suction and/or delivery connection of the pump is connected to the first chamber and the second suction and/or delivery connection is connected to an accumulator chamber, and in that the pump is arranged in the piston or in or on a bottom of the first chamber.

The piston is moved by this fluid linear drive in that, with the aid of the pump, the pressure medium is conveyed into or out of the first chamber designed as a closed-off space. Both an extension and a retraction of the piston rod are thereby possible.

The push-in and push-out speed can be controlled by means of a corresponding activation of the drive of the pump, in particular of an electric motor.

In principle, although it would be conceivable to arrange the pump separately from the cylinder, the pump can be arranged in the piston so as to save construction space and simplify the construction and installation of the linear drive. However, only a small construction space is likewise required when the pump is arranged in or on a bottom of the first chamber. In this case, for example, the pump may be flanged onto the bottom.

The pressure medium may be a gas, in particular nitrogen gas.

It is likewise possible, however, that the pressure medium is a hydraulic fluid, in particular oil, and the second chamber is connected to a volume compensation space.

In this case, the second chamber may form the accumulator chamber so as to save construction space, with the result that a space which is present in any event is utilized.

Where an at least approximately vertical installation with an overhead second chamber is concerned, the second chamber may be subdivided, and the chamber part nearer the piston be filled with hydraulic fluid, and the chamber part further from the piston may form the volume compensation space.

However, so that the fluid linear drive can be installed independently in any position, preferably the first chamber part is separated from the second chamber part by means of a moveable wall, in particular an elastic wall, in each case the moveable wall may be a piston-like partition displaceable in the cylinder.

The volume compensation space is preferably filled with a gas, in particular with nitrogen, which is compressible.

In order to generate a basic pushing force, the gas may be under an admission pressure.

It is thereby possible to compensate the forces acting on the piston in a defined position.

It leads to a compact type of construction when the cylinder is surrounded by an annular chamber forming the accumulator chamber.

In this case, the annular chamber may be connected to the second chamber at that end of the cylinder which is on the piston-rod side.

For the separation of gas and hydraulic fluid, the annular chamber may be separated by a moveable wall into a first annular chamber part forming the accumulator chamber and a second annular chamber part forming the compensation chamber.

If the first chamber is connected to the accumulator chamber via a first prestressed nonreturn valve and/or the accumulator chamber is connected to the first chamber via a second prestressed nonreturn valve, overload protection can be implemented.

So as to reduce the construction space, the first nonreturn valve and/or the second nonreturn valve may be arranged in the piston.

Likewise so as to require small construction space, the first nonreturn valve and/or the second nonreturn valve may be arranged in the wall of the cylinder between that region of the first chamber which is near the bottom and the annular chamber.

If the pump is a swashplate-type axial piston pump or a gear pump, in particular an external gear pump, then the required construction space is small.

Other pumps of another type, such as, for example, an internal gear pump, a reciprocating pump or a diaphragm pump, may also be used as a pump.

For example, in order to open flaps, it is particularly advantageous if, when the pump is arranged in or on a bottom of the first chamber, a booster piston capable of being acted upon with pressure medium by the pump is arranged in or on the first chamber in order to increase the force capable of acting on the piston rod. In particular, this achieves, without a rise in the installed pump power, an increase in the push-out force of the piston and consequently of the overall fluid linear drive.

A simple construction with only a few additional components is obtained when the booster piston has a larger piston area than the piston and is arranged in the first chamber so as to be capable of acting on the piston.

For a simple and permanently reliable transmission of force from the booster piston to the piston and piston rod, the piston or the booster piston, on its piston side facing the first chamber, may have a tappet.

In a position in which the piston rod is retracted into the cylinder, the booster piston may bear against the tappet, so that, even in the first portion of the extension travel of the piston rod, an increased push-out force is available, this being advantageous particularly for the opening of doors and/or flaps.

The effectiveness of the booster piston can preferably be controlled in that the first chamber has a pressure medium bypass line for the booster piston. The pressure medium can then be pumped from the pump into the first chamber, without a movement of the booster piston taking place.

So as to simplify the construction of the fluid linear drive, the pressure medium bypass line may have, for bridging the booster piston, a bypass groove arranged on an inner wall of the first chamber. It is thereby possible, moreover, to control the effectiveness of the booster piston as a function of the travel.

Advantageously, the required construction space for the fluid linear drive can be reduced and the sealing off of the latter simplified when, with the pump being arranged in or on a bottom of the first chamber, a motor arranged outside the cylinder is provided for driving the pump.

A slip-free permanently maintainable transmission of a drive power of the motor to the pump can be obtained in that the pump and the motor are connected to a drive shaft led, sealed off, out of the cylinder.

The drive shaft may be sealed off in a highly cost-effective and low-wear manner with respect to the cylinder by means of a seal having polytetrafluoroethylene (PTFE).

Advantageously, the geometric arrangement of the pump and motor may be configured flexibly and/or an adaptation of the motor output rotational speed to the desired pump drive rotational speed may take place if the pump and the motor are connected to a drive shaft having a first, pump-side shaft portion and a second, motor-side shaft portion connected to the first shaft portion by means of a coupling.

In particular, the sealing off of the cylinder can be considerably simplified and have further-enhanced permanent maintainability if the coupling has a contactless magnetic coupling. In such a case, it becomes possible to arrange, between a first, pump-side coupling element and a second, motor-side coupling element, a cylinder wall through which the drive shaft does not penetrate, with the result that a sealing point otherwise required is dispensed with.

The coupling may have a gearwheel coupling or a toothed-belt coupling, which results particularly in the possibility of arranging the motor laterally, that is to say on a longitudinal side of the cylinder.

A freely moving flexible arrangement of the motor is made possible when the drive shaft has a flexible shaft.

If the motor has a housing sealed off with respect to the cylinder, then, as a result of such additional sealing off of the motor, a seal satisfying lower leaktightness requirements may be used between the drive shaft and cylinder.

In order to prevent pressure medium from running out of the cylinder into the housing and therefore possibly also into the motor, the housing may be filled with a housing pressure medium. The pressure of the housing pressure medium is preferably as high as the pressure of the pressure medium in the cylinder. In order to prevent an overflow of housing pressure medium into the cylinder, a sealing off of the drive shaft also with respect to the cylinder must be provided.

The housing pressure medium may cost-effectively be a gas.

If a motor capable of running in oil, in particular an electronically commutated electric motor, is used, the housing pressure medium may be an oil, for example a hydraulic oil.

The motor may possibly be an electric motor and have an electrical connection led, sealed off, out of the housing. The connection may have, for example, a rubber seal for sealing off or, for example, be cast or injected into the housing.

In order to limit the speed of movement of the piston rod, a throttle and a nonreturn valve shutting off a backflow from the first chamber or the second chamber may be arranged in a connection from the first suction and/or delivery connection to the first chamber and/or in a connection from the second suction and/or delivery connection.

In this case, preferably, the throttle and the nonreturn valve are designed as a throttle nonreturn valve.

Advantageously, as overload protection, the first chamber and/or the second chamber may be connected to the second chamber and/or the first chamber via a pressure limiting valve.

It leads to a compact and simple construction when the swashplate-type axial piston pump possesses a cylinder drum which can be driven rotatably about an axis of rotation and in which pump cylinders parallel to the axis of rotation are formed, the pump cylinders having arranged displaceably in them pistons which project at one end out of the pump cylinders and are supported on a stationary swashplate inclined at an angle with respect to the axis of rotation, suction/delivery bores leading from those ends of the pump cylinders which are opposite the pistons to a stationary control plate, against which the cylinder drum is supported axially and which is provided with a kidney-shaped delivery port connected to the delivery connection and with a kidney-shaped suction port connected to the suction connection, the kidney-shaped delivery port and kidney-shaped suction port extending concentrically with respect to the axis of rotation, and the issues of the suction/delivery bores which are located on the control-plate side being capable of overlapping with the kidney-shaped delivery port and kidney-shaped suction port during the rotational movement of the cylinder drum.

Complicated bearing means may be dispensed with if the cylinder drum possesses a radially continuous cylindrical outer surface area, by means of which it is rotatably mounted completely or partially in a bearing bore of a stationary pump housing.

If in this case the cylinder drum has on its cylindrical outer surface area a concentric radially outward-projecting bearing ring, by means of which the cylinder drum is mounted rotatably in the bearing bore, then the liquid friction in the gap between the cylinder drum and bearing bore is reduced, thus leading to a reduction in the bearing resistances. It is consequently possible for the pump to be designed with a smaller drive.

This is likewise achieved when the bearing bore has a concentric radially inward-projecting bearing ring on which the cylinder drum is mounted rotatably in the bearing bore.

For at least largely avoiding a tilting movement acting on the cylinder drum, the bearing ring is preferably arranged in the region near the control plate.

For carrying out the suction stroke of the pistons, these may be acted upon in a simple way indirectly or directly against the swashplate by means of the compression springs which are supported on the cylinder drum.

The compression springs are in this case preferably helical compression springs which are arranged in the pump cylinders and which are supported with their one end on those ends of the pistons which are on the control-plate side and with their other end on those bottoms of the pump cylinders which are on the control-plate side.

In order to avoid a friction of the helical compression springs on the walls of the pump cylinders and therefore damage leading to leakage losses, and also losses due to friction, the helical compression springs may possess a smaller diameter than the pump cylinders.

Damage to the walls of the pump cylinders which leads to leakage losses is also avoided in that the pistons possess, at their ends on the control-plate side, a region of smaller diameter than the diameter of the pump cylinders, the region of smaller diameter extending at least over a length corresponding to the piston stroke.

A centric guidance of the helical compression springs in the pump cylinders is achieved in that the piston-side end of the helical compression springs projects into a coaxial bore in the piston or surrounds a tenon-like coaxial extension of the piston, said coaxial extension projecting toward the control plate.

It leads to a considerable reduction in the friction between the cylinder drum and control plate when the cylinder drum is supported axially on the control plate via an axial bearing, in particular an axial rolling bearing.

As a result, a considerably lower design rating of the force of the drive of the pump and therefore a markedly smaller construction size are possible, thus also leading to a lower construction space requirement of the fluid linear drive and to a lower energy requirement.

If, in this case, the axial bearing is arranged in a radially continuous groove on that end face of the cylinder drum which is on the control-plate side, this leads to a further reduction in the construction size of the pump and of the fluid linear drive.

In that end face of the control plate which faces the cylinder drum, one or more concentric relief grooves may be formed, which extend radially inside and/or radially outside the kidney-shaped delivery port and kidney-shaped suction port and/or in the region of the second axial bearing and from which one or more discharge ducts lead to a reservoir.

Consequently, both leakage and squeeze oil are discharged as far as possible directly after their occurrence. Moreover, this leads to a reduction in the supporting surface of the cylinder drum on the control plate and therefore also to a reduction in losses due to friction.

In order to keep the effective supporting surface of the cylinder drum and consequently losses due to friction and construction size as small as possible, the suction/delivery bores may be arranged so as to be offset with respect to the center axis of the pump cylinders radially in relation to the axis of rotation of the cylinder drum.

In order likewise to keep the friction between the pistons and the swashplate as low as possible, it is possible for the pistons to be supported on the swashplate via a second axial bearing, in particular a second axial rolling bearing.

It is consequently possible for the drive to have a lower design rating, thus leading to a smaller construction size of the pump and fluid linear drive and to a lower energy requirement.

Furthermore, it is also possible to dispense with complicated sliding shoes between piston and swashplate, since only the smallest possible relative movement takes place between the pistons and the swashplate.

A low-friction support of the pistons is in this case possible in a simple way in that the pistons are designed convexly, in particular hemispherically, at their end bearing against the axial bearing.

So that no frictional contact occurs between the axial bearing and the wall of the bearing bore of the pump housing, the second axial bearing may be arranged, guided radially, on the swashplate.

This is possible in a simple way in that that end face of the swashplate which faces the cylinder drum has a ring-like or disk-like depression of the same outer contour as the outer contour of the annular second axial bearing, in which depression the second axial bearing is arranged.

Alternatively, a projecting appendage may also be arranged on that end face of the swashplate which faces the cylinder drum, the circular cross section of which appendage corresponds to the cross section of the circular inner contour of the second axial bearing, the second axial bearing being arranged with its circular inner contour on the appendage.

In order to assign the suction and delivery strokes of the pistons correctly to the kidney-shaped suction port and the kidney-shaped delivery port, the swashplate must be aligned exactly with the control level. For this purpose, in a simple design, the swashplate and/or the control plate may be connected to the pump housing fixedly in terms of rotation with respect to one another via positioning elements, for which purpose the swashplate and/or the control plate may have, on a surface bearing against the pump housing, a recess into which the positioning element arranged fixedly on the pump housing projects.

The positioning element can in this case be produced in a simple way if it is a deformation of the pump housing, said deformation being generated by indentation.

It leads to a compact arrangement when the cylinder drum can be driven rotatably by a coaxial drive shaft of a drive.

In this case, to compensate a tolerance-related axial offset of the drive shaft and cylinder drum, the drive shaft may be coupled to a coaxial tenon of the cylinder drum via a slotted coupling which, in particular, is an Oldham coupling.

Losses due to friction are in this case reduced even further when the intermediate disk of the Oldham coupling is a plastic injection molding.

So that the cylinder drum does not lift off from the control plate and thereby leads to leakage losses, the sum of the cross-sectional areas of the pump cylinders located in each case above the kidney-shaped delivery port, minus the sum of the cross-sectional areas of the suction/delivery bores of these pump cylinders, may be in a ratio of >1.8:1, preferably between 2.0:1 and 3.3:1, to that area of the kidney-shaped delivery port which faces the cylinder drum.

A ratio of 2.06:1 has proved particularly advantageous.

One possibility for the design of the pistons is to produce the pistons in one part.

However, the pistons may also be of multipart design.

If the piston consists of a cylinder ring, on one end face of which a convex, in particular hemispherical supporting part is fixedly arranged coaxially and on the other end face of which a coaxial tubular part of smaller diameter than the diameter of the cylinder ring is fixedly arranged, then a good bearing contact against the swashplate and a prevention of the wear of the pump cylinders in the region of the helical compression springs are achieved. The coaxial tubular part may consist of a hard wear-resistant material and be produced with low tolerances.

It is also possible, however, for the piston to consist of a cylinder ring, on one end face of which a convex, in particular hemispherical supporting part is fixedly arranged coaxially.

Another possibility for the design of the piston is for the piston to be formed from one ball or a plurality of balls lined up with one another, which possess the same diameter as the pump cylinder, the ball nearest the swashplate projecting partially out of the pump cylinder and being in bearing contact against the swashplate or the second axial bearing.

If there are a plurality of balls, the gap losses during the pump stroke are reduced.

Exemplary embodiments of the invention are illustrated diagrammatically in the drawing and are described in more detail below. In the drawing:

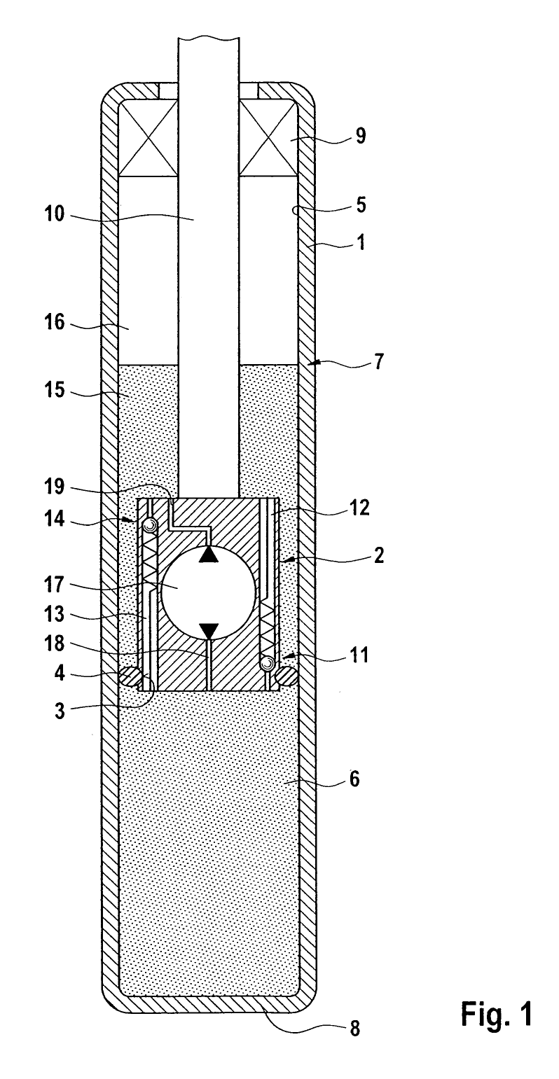

FIG. 1 shows a first exemplary embodiment of a fluid linear drive in section,

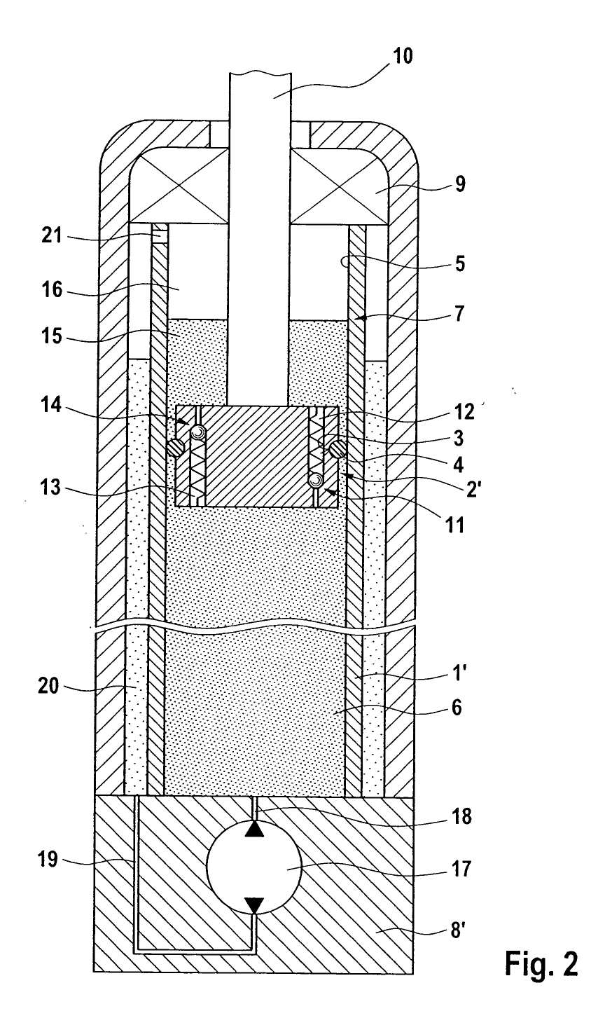

FIG. 2 shows a second exemplary embodiment of a fluid linear drive in section,

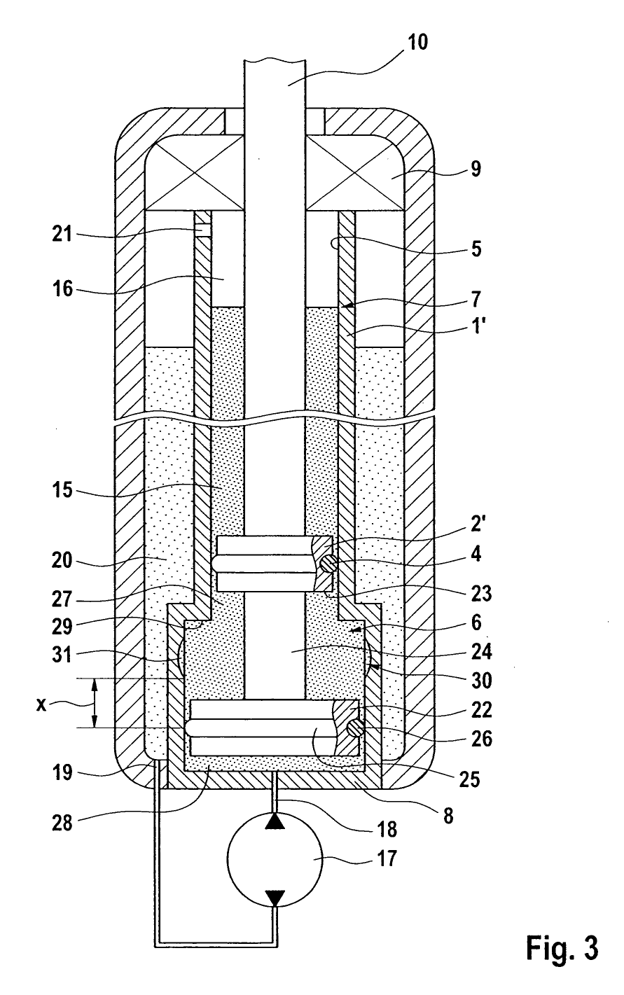

FIG. 3 shows a third exemplary embodiment of a fluid linear drive in section,

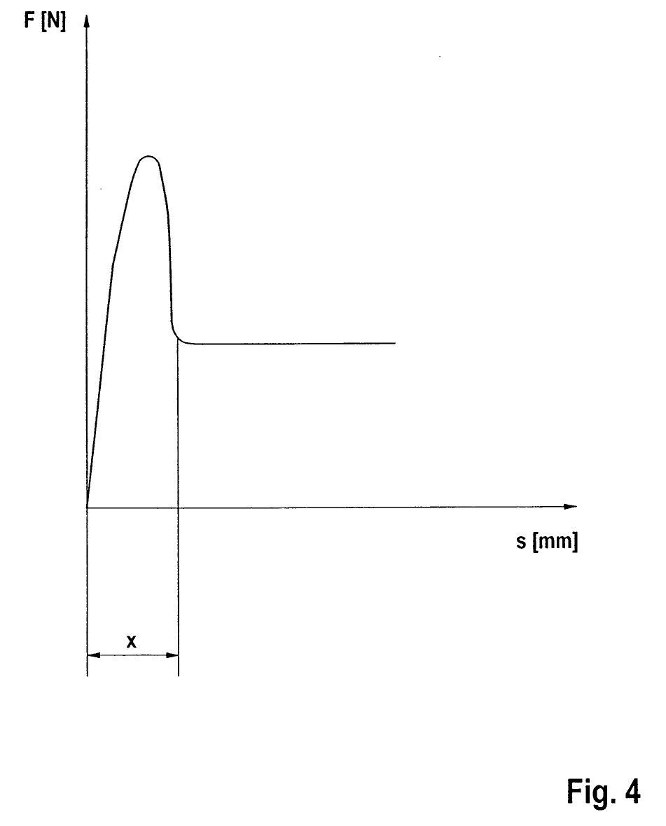

FIG. 4 shows a force-path graph relating to the fluid linear drive according to FIG. 3,

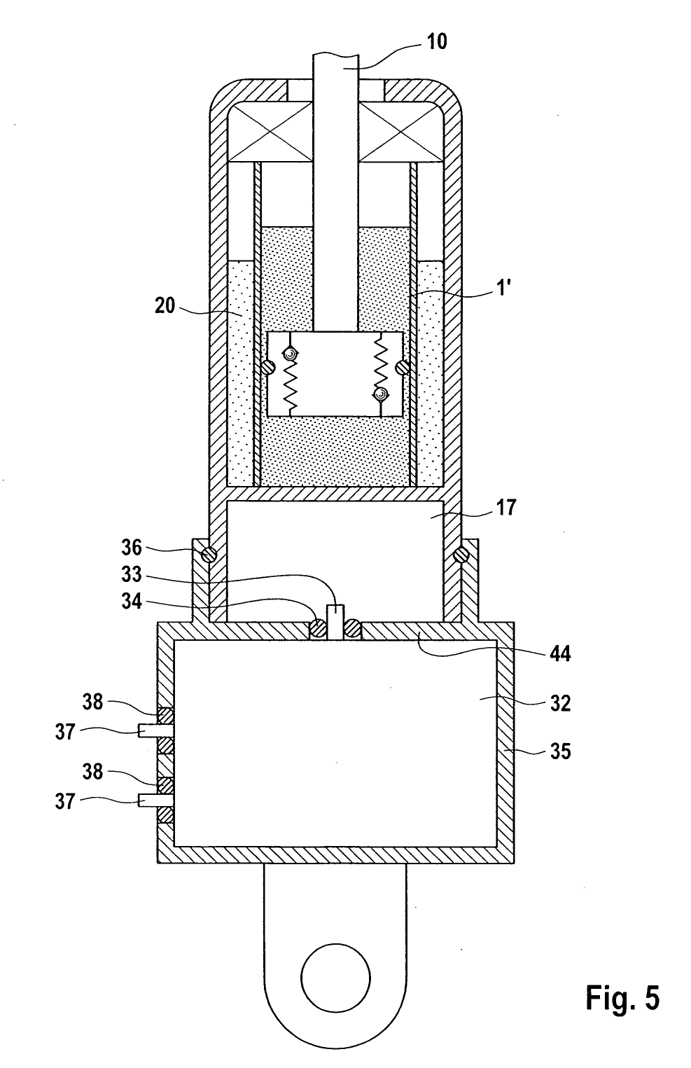

FIG. 5 shows a fourth exemplary embodiment of a fluid linear drive in section,

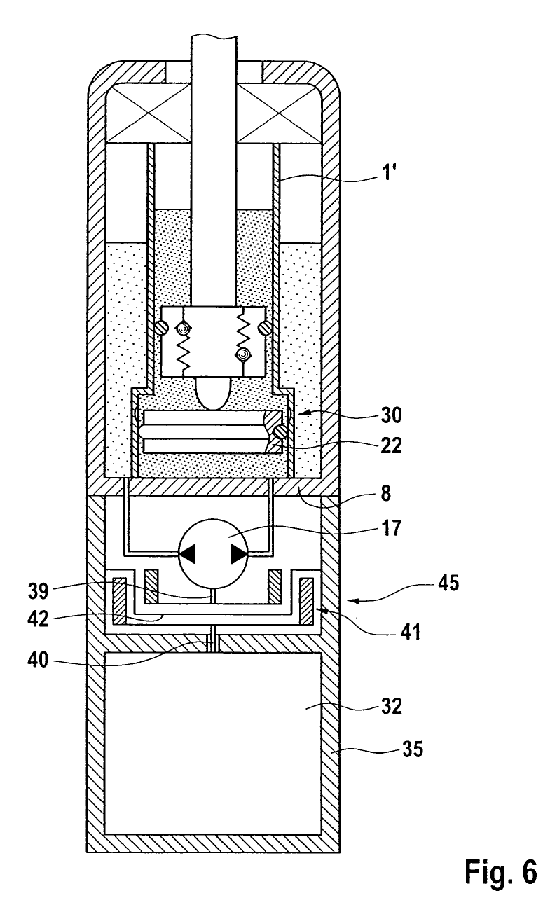

FIG. 6 shows a fifth exemplary embodiment of a fluid linear drive in section, and

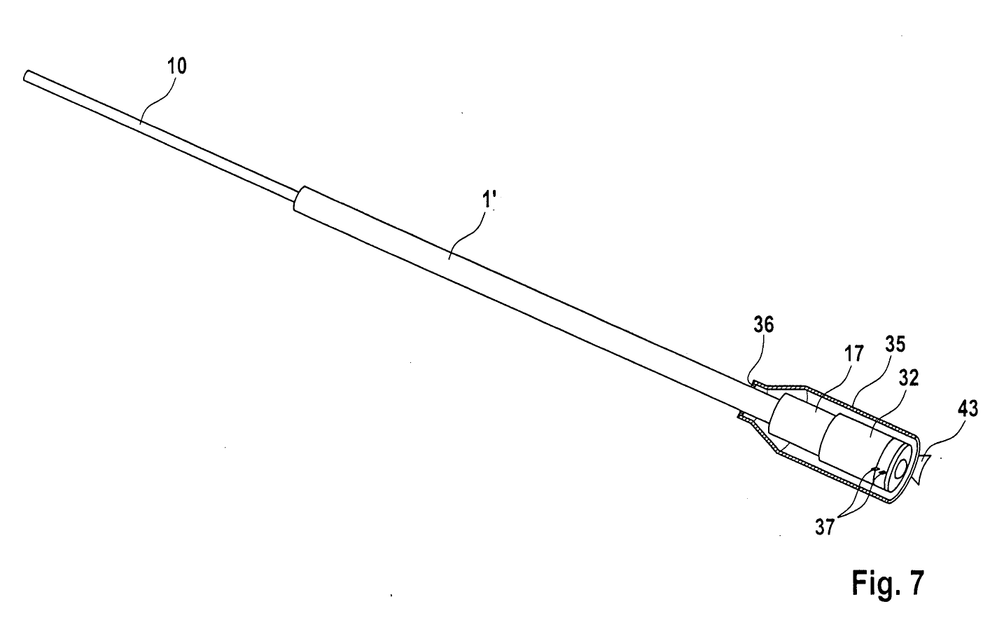

FIG. 7 shows a sixth exemplary embodiment of a fluid linear drive in a partially sectional perspective view,

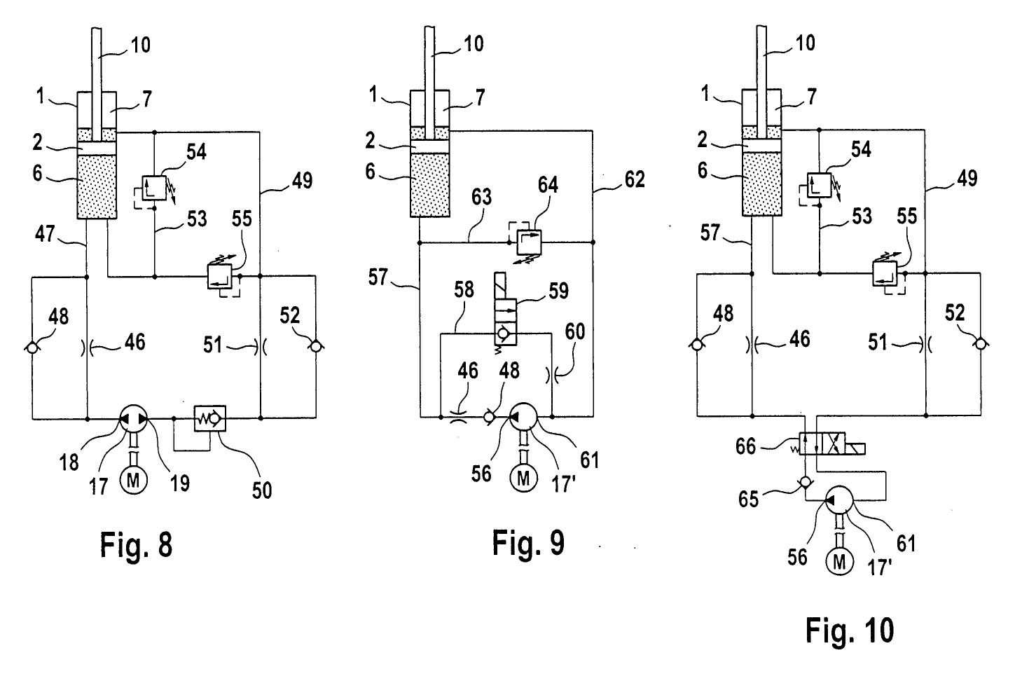

FIG. 8 shows a first exemplary embodiment of a circuit diagram of a fluid linear drive,

FIG. 9 shows a second exemplary embodiment of a circuit diagram of a fluid linear drive,

FIG. 10 shows a third exemplary embodiment of a circuit diagram of a fluid linear drive,

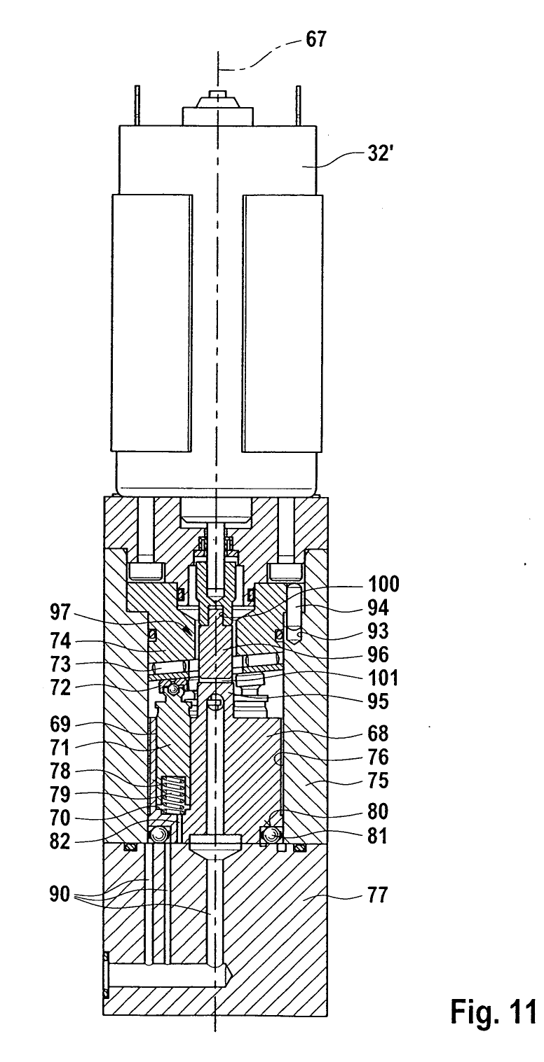

FIG. 11 shows a cross section of a first exemplary embodiment of a swashplate-type axial piston pump,

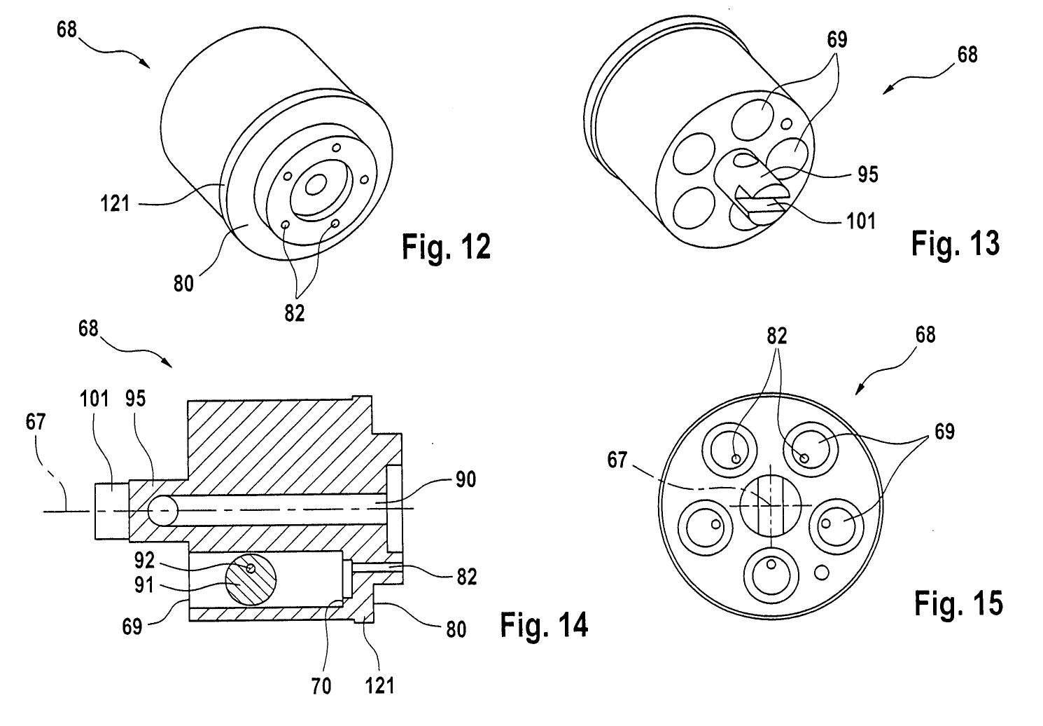

FIG. 12 shows a perspective view of the cylinder drum of the swashplate-type axial piston pump according to FIG. 1, as seen from the control-plate side,

FIG. 13 shows a perspective view of the cylinder drum of the swashplate-type axial piston pump according to FIG. 1, as seen from the swashplate side,

FIG. 14 shows a cross section of the cylinder drum according to FIG. 12,

FIG. 15 shows a swashplate-side view of the cylinder drum according to FIG. 12,

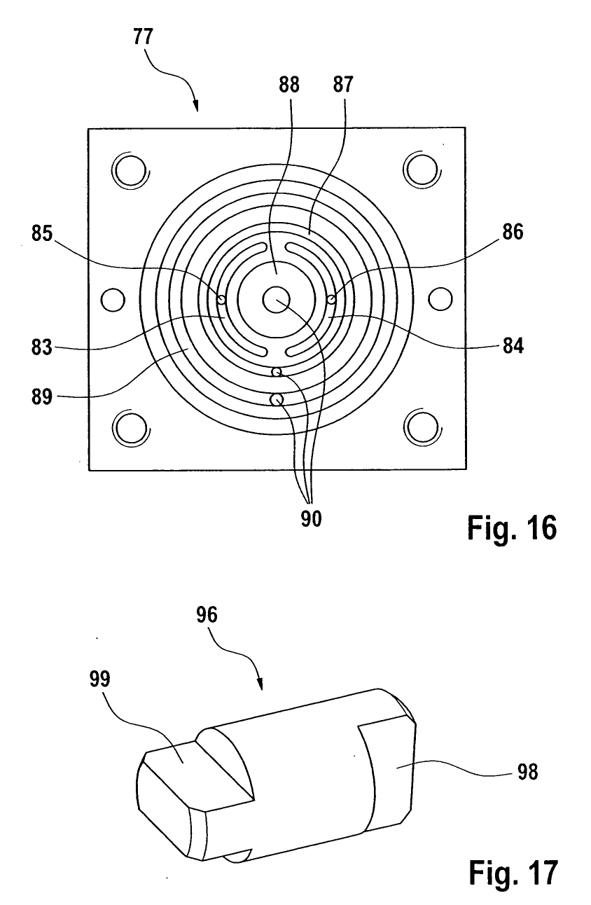

FIG. 16 shows a cylinder drum-side view of the control plate of the swashplate-type axial piston pump according to FIG. 12,

FIG. 17 shows a perspective view of the intermediate part of the slotted coupling of the swashplate-type axial piston pump according to FIG. 12,

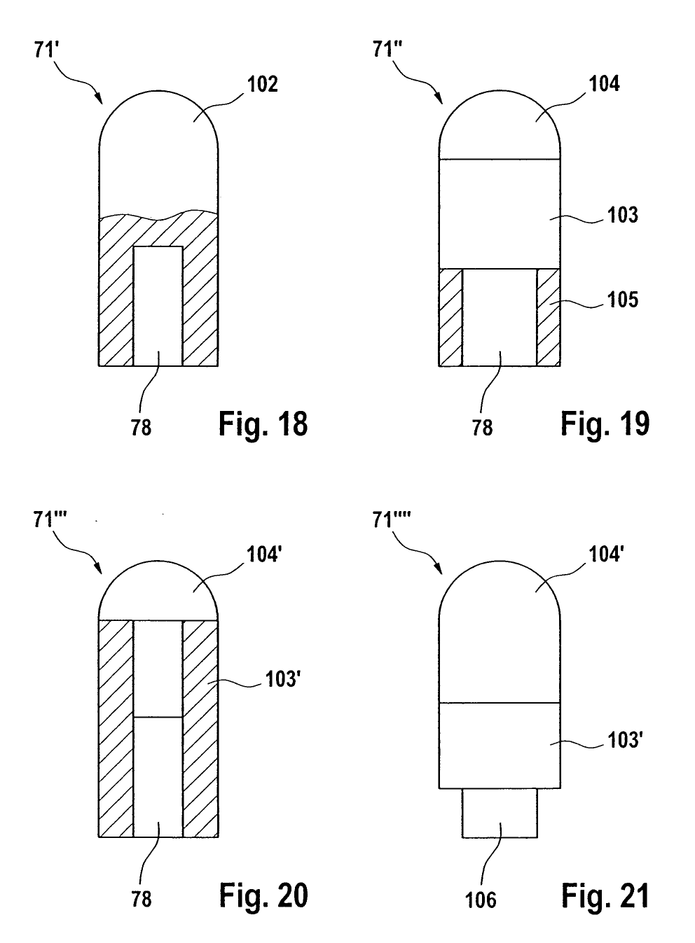

FIG. 18 shows a partial sectional view of a one-part piston,

FIG. 19 shows a partial sectional view of a three-part piston,

FIG. 20 shows a sectional view of a two-part piston,

FIG. 21 shows a view of a piston with reduced diameter at the end located on the control-plate side,

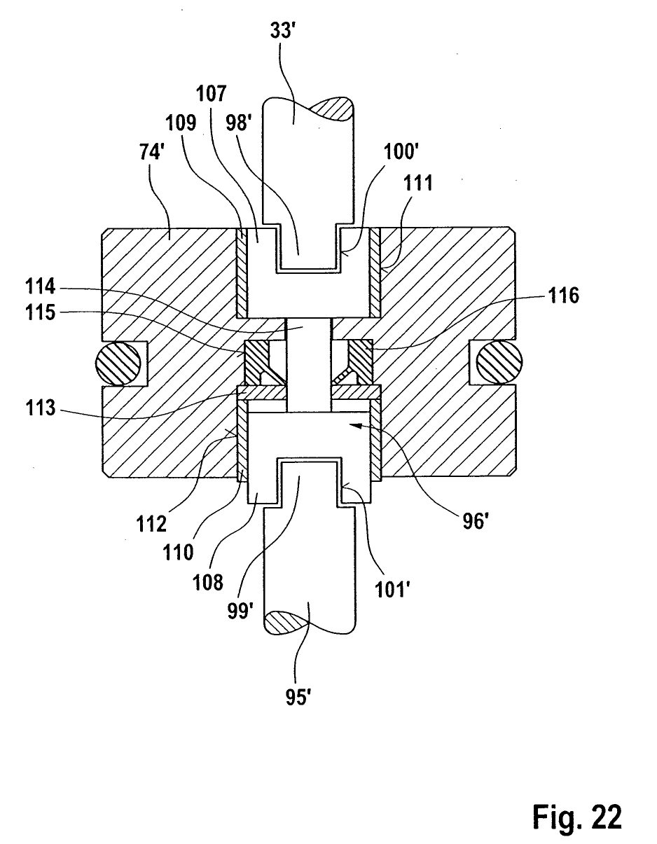

FIG. 22 shows a cross section of a second exemplary embodiment of a swashplate-type axial piston pump in the region of the swashplate,

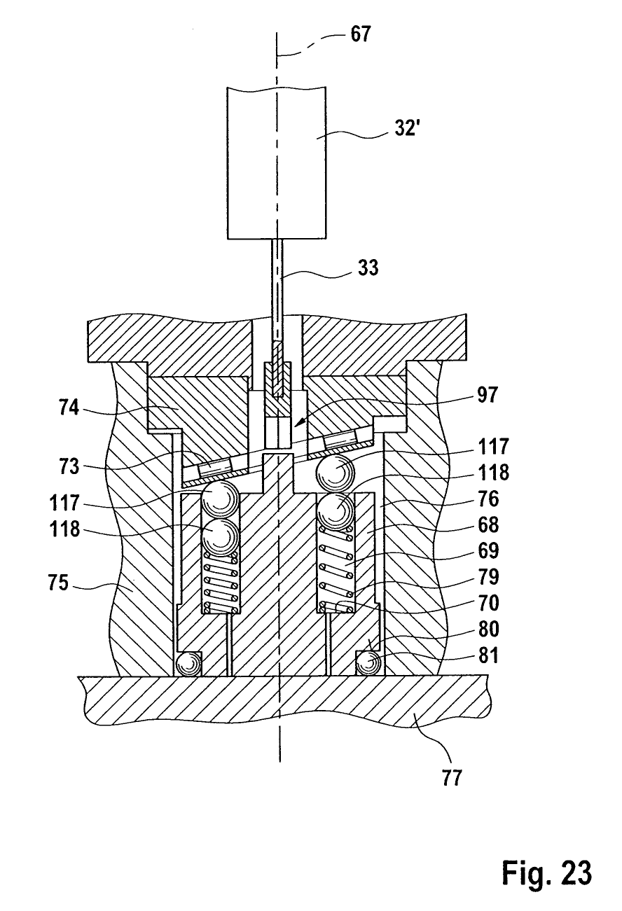

FIG. 23 shows a cross section of a third exemplary embodiment of a swashplate-type axial piston pump,

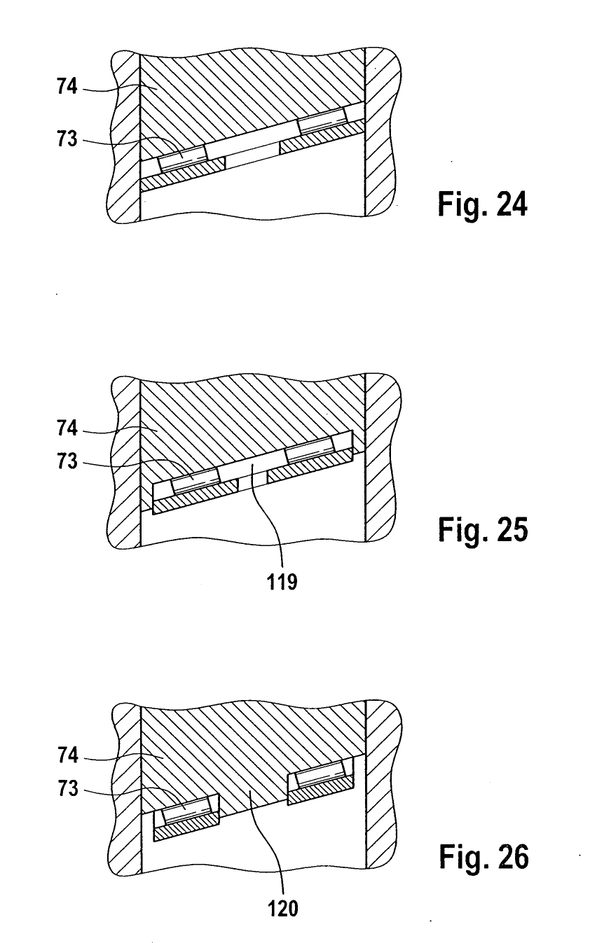

FIG. 24 shows a side view of a first exemplary embodiment of a swashplate-side axial rolling bearing,

FIG. 25 shows a side view of a second exemplary embodiment of a swashplate-side axial rolling bearing,

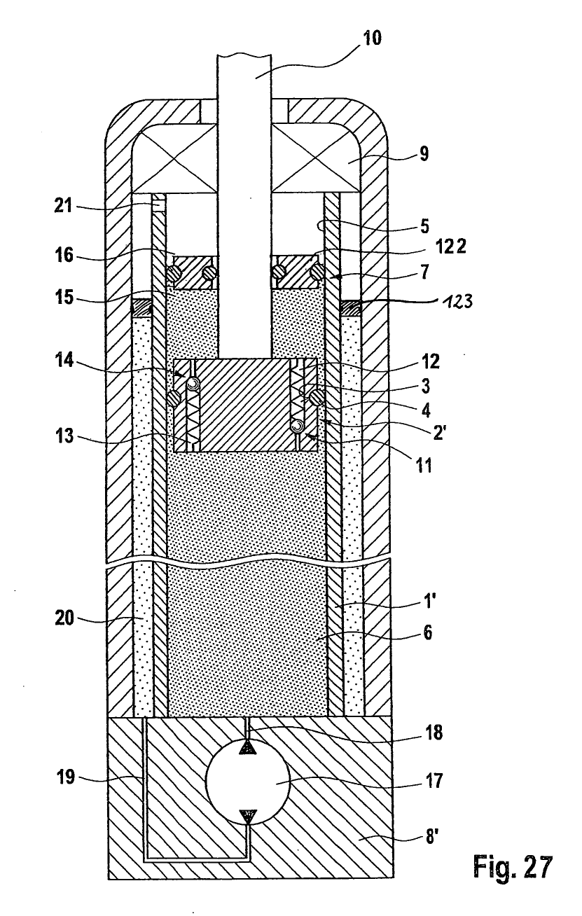

FIG. 26 shows a side view of a third exemplary embodiment of a swashplate-side axial rolling bearing.

The fluid linear drives illustrated in FIGS. 1, 2 possess a cylinder 1, 1′ in which a piston 2, 2′ is arranged displaceably.

The piston 2, 2′ possesses, on its radially continuous outer surface area, a radially continuous annular groove 3, into which a sealing ring 4 is inserted which bears sealingly against the inner wall 5 of the cylinder 1, 1′.

The inner space of the cylinder 1, 1′ is subdivided into a first chamber 6 and a second chamber 7 by the piston 2, 2′.

The cylinder 1, 1′ is closed at one end by means of a bottom 8, 8′ and at its other end by means of a sealing and guide unit 9. A piston rod 10 is sealingly guided displaceably through a coaxial hole in the sealing and guide unit 9 and is fastened at one end to the piston 2, 2′, its other end projecting out of the cylinder 1, 1′.

The piston 2, 2′ possesses a first nonreturn valve 11 which is prestressed by a spring and which is arranged in a first connecting line 12 leading from the first chamber 6 to the second chamber 7.

Furthermore, a second nonreturn valve 14 prestressed by a spring is arranged, so as to open in opposition to the first nonreturn valve, in a second connecting line 13 which leads from the second chamber 7 to the first chamber 6.

The second chamber 7, through which the piston rod 10 is guided, is subdivided into a chamber part 15 nearer the piston 2, 2′ and a chamber part 16 further from the piston 2, 2′.

The first chamber 6 and the chamber part 15 nearer the piston are filled with oil, while the chamber part 16 further from the piston 2, 2′ forms a volume compensation space filled with prepressurized gas.

In the exemplary embodiment of FIG. 1, the piston 2 has arranged in it a reversibly drivable pump 17 which possesses a first suction/delivery connection 18 leading to the first chamber 6 and a second suction/delivery connection 19 leading to the chamber part 15.

In the exemplary embodiment of FIG. 2, a reversibly drivable pump 17 is arranged in the bottom 8′. A first suction/delivery connection 18 of the pump 17 leads to the first chamber 6, and a second suction/delivery connection 19 of the pump 17 leads to the end, near the bottom 8′, of an annular chamber 20 surrounding the cylinder 1′.

The annular chamber 20 forms an accumulator chamber, of which the region nearer the bottom 8′ is filled with oil and the opposite end region is filled with gas. At the end opposite the bottom 8′, the annular chamber 20 is connected to the chamber part 16 by means of a radial orifice 21 in the cylinder 1′.

When, in the exemplary embodiment of FIG. 1, oil is sucked in from the chamber part 15 by the pump 17 by the second suction/delivery connection 19 and is conveyed into the first chamber 6 by the first suction/delivery connection 18, the piston 2 and, with it, the piston rod 10 are moved in the extension direction.

With the conveying direction reversed, the pump 17 sucks in oil from the first chamber 6 by the first suction/delivery connection 18 and conveys it into the chamber part 15 by the second suction/delivery connection 19, with the result that the piston and piston rod 10 are moved in the retraction direction.

The gas in the chamber part 16 ensures volume compensation by virtue of its compressibility.

In the exemplary embodiment of FIG. 2, in one conveying direction of the pump 17, a suction of oil from the first chamber 6 via the first suction/delivery connection 18 and a conveyance of the oil into the annular chamber 20 via the suction/delivery connection 19 take place, so that the piston 2′ and piston rod 10 are retracted.

The reversed conveying direction leads to a movement of the piston 2′ and piston rod 10 in the extension direction.

Here, too, the gas in the chamber part 16 and in the upper part of the annular chamber 20 ensures volume compensation by virtue of its compressibility.

If, during an extension movement of the piston 2, 2′ and piston rod 10, the resistance acting on the piston rod 10 increases beyond a specific force level, the pressure in the first chamber 6 also rises, until the first nonreturn valve 11 opens counter to the force of its spring, and, despite further conveyance by the pump 17, oil can flow from the first chamber 6 into the chamber part 15. As a result, the piston 2, 2′ and the piston rod remain in their position and are not moved any further, until the increased resistance acting on them is terminated.

In the same way, during a retraction movement of the piston 2, 2′ and piston rod 10, the second nonreturn valve 14 opens when increased resistance occurs, and allows a stream of oil from the first chamber part 15 into the first chamber 6.

This function may be utilized as overload or pinch protection, for example, in an application of the fluid linear drive for the adjustment of flaps and doors particularly in motor vehicles.

FIG. 3, in which, as in the following figures, the same reference symbols as in FIGS. 1, 2 are used for structural elements corresponding in each case to one another, shows a fluid linear drive with a cylinder 1′, which fluid linear drive is constructed in a similar way to the fluid linear drive according to FIG. 2 and has a reversibly drivable pump 17 on the bottom 8 of a first chamber 6 of the cylinder 1′.

A first suction/delivery connection 18 of the pump 17 leads to the first chamber 6, and a second suction/delivery connection 19 of the pump 17 leads to an end, near the bottom 8, of an annular chamber 20 surrounding the cylinder 1′.

Here, too, this annular chamber 20 forms an accumulator chamber, of which the region nearer the bottom 8 is filled with oil and the end region opposite this region is filled with gas. At the end opposite the bottom 8, the annular chamber 20 is connected by means of a radial orifice 21 in the cylinder 1′ to a chamber part 16, further from the piston, of a second chamber 7 of the cylinder 1′.

The first chamber 6 and the second chamber 7 of the cylinder 1′ are separated by a piston 2′ which has a piston rod 10 and which is arranged displaceably in the cylinder 1′. The piston 2′ has on its circumference a sealing ring 4 which bears sealingly against the inner wall 5 of the cylinder 1′.

The first chamber 6 and a chamber part 15, nearer the piston, of the second chamber 7, through which the piston rod 10 is guided, are filled with oil, whereas the chamber part 16, further from the piston 2′, of the second chamber 7 forms a volume compensation space filled with prepressurized gas. A sealing and guide unit 9, on the one hand, closes the cylinder 1′ on its side facing away from the bottom 8 and, on the other hand, guides the piston rod 10, sealed off, out of the cylinder 1′.

A booster piston 22, which has a larger piston area than the piston 2′, is arranged in the first chamber 6 in order to increase the force capable of acting on the piston rod 10. For this purpose, the piston 2′ has, on its piston side 23 facing the first chamber 6, a tappet 24 arranged centrically and perpendicularly to the piston 2′. In a position in which the piston rod 10 is retracted into the cylinder 1′ and which is illustrated here, the booster piston 22, which is provided on its circumference with an annular groove 25 and with a sealing ring 26 arranged in the latter, bears against the tappet 24.

In the region of the booster piston 22 which subdivides the first chamber 6 into a piston-side chamber part 27 and a pump-side chamber part 28, the first chamber 6 has a larger diameter than it has in the region of the piston 2′, this being achieved by means of a step 29 on the inner wall 5 of the cylinder 1′.

Furthermore, the first chamber 6 is provided with a pressure medium bypass line 30 for the booster piston 22, the pressure medium bypass line having a plurality of bypass grooves 31 for bridging the booster piston 22 which are arranged on the inner wall of the first chamber 6 and run in the cylinder longitudinal direction.

When pressure medium is pumped into the first chamber 6 by means of the pump 17 via the suction/delivery connection 18 connected to the first chamber 6, a pressure for pushing out the piston rod 10 first acts on the comparatively large piston area of the booster piston 22. A high push-out force is consequently made available, which is transmitted by the booster piston 22 to the piston rod 10 via the tappet 24 and the piston 2′.

After the booster piston 22 has executed a structurally adjustable active travel x, the booster piston 22 comes into the region of the bypass grooves 31. The booster piston 22 stops here, even when acted upon further by pressure, and the pressure medium conveyed by the pump 17 flows around the booster piston 22 and acts directly upon the piston 2′ which thereupon, together with the tappet 24, moves away from the booster piston 22.

When the piston rod 10 is pushed into the cylinder 1′, the booster piston 22 is pushed back into its initial position by the piston 2′ by means of the tappet 24.

An adaptation of the push-out force of the cylinder 1′ to the force requirement necessary and/or desired according to the application may take place via the piston area and/or the active travel x of the booster piston 22.

An exemplary force/path graph, shown in FIG. 4, in which a push-out force F of the cylinder 1′ is illustrated as a function of a travel s of the piston 2′, makes clear the type of operation of the fluid linear drive according to FIG. 3. In particular, a lowering of the push-out force F to a constant force level after the booster piston 22 has executed its active travel x becomes clear.

The following exemplary embodiment according to FIG. 5 also shows a fluid linear drive similar to the exemplary embodiments according to FIGS. 2, 3 and having a cylinder 1′ which is surrounded by an annular chamber 20 and out of which a piston rod 10 is led.

Here, a motor 32 arranged outside the cylinder 1′ and designed as an electric motor is provided for driving a pump 17, the pump 17 and the motor being connected to a drive shaft 33 guided, sealed off, out of the cylinder 1′. The drive shaft 33 is sealed off with respect to the cylinder 1′ by means of a seal 34 having PTFE.

Moreover, the motor 32 has a housing 35 which is sealed off with respect to the cylinder 1′ by means of a seal 36. A wall, facing the cylinder 1′, of the housing 35 at the same time forms a wall 44 of the cylinder 1′, through which wall 44 the drive shaft 33 is guided, sealed off, out of the cylinder 1′. Furthermore, electrical connections 37 for contacting the motor 32 are led, sealed off by means of seals 38, out of the housing 35.

A fluid linear drive again of similar construction is shown in FIG. 6, wherein, correspondingly to the exemplary embodiment according to FIG. 3, a booster piston 22 in a cylinder 1′ with a pressure medium bypass line 30 is provided.

A motor 32 which is arranged outside the cylinder 1′ and is designed as an electric motor and which has, for example, a power of 40 W and a diameter of 29 mm, for the drive of a pump 17, is connected to the pump 17 via a drive shaft. The drive shaft has a first, pump-side shaft portion 39 and a second, motor-side shaft portion 40, which shaft portions 39, 40 are connected by means of a torque transmission coupling 45 designed as a contactless magnetic coupling 41.

The motor 32 is arranged in a housing 35 which is closed off by means of a nonmagnetic sealing wall 42 with respect to the cylinder 1′ and to the pump 17 which is arranged on a bottom 8 of the cylinder 1′.

A further fluid linear drive with a cylinder 1′, out of which a piston rod 10 is extended completely, is shown in FIG. 7. A motor 32 driving a pump 17 is provided with a housing 35 consisting, for example, of an elastic material. The housing 35 is sealed off with respect to the cylinder 1′ by means of a seal 36.

Electrical connections 37 of the motor 32 are led, sealed off, out of the housing 35 which, moreover, has a mechanical connection 43 for fastening the fluid linear drive.

In the circuit diagram of a fluid linear drive, as illustrated in FIG. 8, a reversible pump 17 is connected via its first suction and delivery connection 18 to a first chamber 6 of a vertically arranged cylinder 1 which is separated by a piston 2 from a second chamber 7 through which a piston rod 10 is guided outward. In this case, in this connection 47 a throttle 46 and, parallel to this, a first nonreturn valve 48 shutting off in the direction of the first chamber 6 are arranged.

The first chamber 6 is filled with a hydraulic fluid, while the second chamber 7 is filled only partially with hydraulic fluid. The other part of the second chamber 7 is filled with a gas which is under pressure.

A second connection 49 leads from the second suction/delivery connection 19, via a nonreturn valve 50 releasable by the conveying pressure on the second suction and delivery connection 19, to the second chamber 7 of the cylinder 1, a throttle 51 and, parallel to this, a second nonreturn valve 52 shutting off in the direction of the second chamber 7 also being arranged in this connection 49. The releasable nonreturn valve 50 shuts off a flow in the direction of the pump 17.

Furthermore, a third connection 53 leads from the first chamber 6, via a first pressure limiting valve 54, to the second connection 49 which, in turn, is connected to the third connection 53 via a second pressure limiting valve 55.

By the two combinations of throttle 46 and nonreturn valve 48 and a throttle 51 and nonreturn valve 52, a limitation of the speed of the piston 2 and piston rod takes place.

Owing to the reversibility of the pump 17, the piston rod 10 can be driven both in the extension direction and in the retraction direction.

In the circuit diagram of a fluid linear drive, as illustrated in FIG. 9, a delivery connection 56 of a nonreversible pump 17′ is connected via a fourth connection 57 to the first chamber 6 of a vertically arranged cylinder 1, the first chamber being separated by a piston 2 from a second chamber 7 through which a piston rod 10 is guided outward. In this case, a first nonreturn valve 48 shutting off in the direction of the first chamber 6 and a throttle 46 are arranged in series in this connection 57.

The first chamber 6 is filled with a hydraulic fluid, while the second chamber 7 is filled only partially with hydraulic fluid. The other part of the second chamber 7 is filled with a gas which is under pressure.

A fifth connection 58 branches off downstream of the throttle 46 from the fourth connection 57 and leads via a magnetically actuated 1/2-way valve 59 and a further throttle 60 to a suction connection 61 of the pump 17′.

In the nonactuated basic position, the 1/2-way valve shuts off the valve passage, whereas, in the event of magnetic actuation, the valve passage is open.

Furthermore, the suction connection 61 of the pump 17′ is connected to the second chamber 7 via a sixth connection 62.

A seventh connection 63 leads from the fourth connection 57 to the sixth connection 62, a third pressure limiting valve 64 being arranged in the seventh connection.

In this exemplary embodiment, an extension movement of the piston rod takes place as a result of the conveyance of hydraulic fluid into the first chamber 6, while, for the retraction movement, the piston rod 10 must be acted upon by an external force.

In the circuit diagram of a fluid linear drive, as illustrated in FIG. 10, a delivery connection 56 of a nonreversible pump 17′ is connected via a fourth connection 57 to the first chamber 6 of a vertically arranged cylinder 1, the first chamber being separated by a piston 2 from a second chamber 7 through which a piston rod 10 extends outward.

The first chamber 6 is filled with a hydraulic fluid, while the second chamber 7 is filled only partially with hydraulic fluid. The other part of the second chamber 7 is filled with a gas which is under pressure.

In the connection 57, first a nonreturn valve 65 shutting off a return to the delivery connection 56 and then a magnetically actuated 2/2-way valve 66 are arranged.

In the nonactuated position of the 2/2-way valve 66, the delivery connection 56 is connected to the connection 57 which leads to the first chamber 6 and in which a throttle 46 and, parallel to this, a first nonreturn valve 48 shutting off in the direction of the first chamber 6 are arranged.

A second connection 49, which leads to the second chamber 7 and in which a throttle 51 and, parallel to this, a second nonreturn valve 52 shutting off in the direction of the second chamber 7 are arranged, is connected to the suction connection 61 of the pump 17′ via the 2/2-way valve 66 in the nonactuated position of the latter.

In the magnetically actuated position of the 2/2-way valve 66, the delivery connection 56 of the pump 17′ is connected via the second connection 49 to the second chamber 7 and the first chamber 6 is connected via the fourth connection 57 to the suction connection 61 of the pump.

Furthermore, a third connection 53 leads from the first chamber 6 via a first pressure limiting valve 54 to the second connection 49 which, in turn, is connected to the third connection 53 via a second pressure limiting valve 55.

The piston rod 10 can be driven both in the extension direction and in the retraction direction by means of the 2/2-way valve 66.

Owing to the two combinations of throttle 46 and nonreturn valve 48 and of throttle 51 and nonreturn valve 52, a limitation of the speed of the piston 2 and piston rod takes place.

In the exemplary embodiments of FIGS. 8 to 10, the pressure limiting valve 54, 55 and 64 form an overload protection, and, in this context, an overload may be caused by too high a load to be moved or else by an obstacle in the range of movement of the piston rod 10.

The swashplate-type axial piston pump illustrated completely or in parts in FIGS. 11 to 17 possesses a cylinder drum 68 capable of being driven rotatably about an axis of rotation 67 by a motor 32′.

The cylinder drum 68 has formed in it, concentrically to the axis of rotation 67 and uniformly distributed, five pot-like pump cylinders 69 which extend parallel to the axis of rotation 67 and extend outward at one end. The pump cylinders 69 possess bottoms 70 at their other end.

Arranged displaceably in the pump cylinders 69 are pistons 71 which project with their one ends out of the pump cylinder 69 and are supported by means of a sliding shoe 72, via a second axial rolling bearing 73, on a stationary swashplate 74 inclined at an angle to the axis of rotation 67. The swashplate 74 is arranged fixedly on a pump housing 75 and projects into a bearing bore 76 of the pump housing 75, in which bearing bore the cylinder drum 68 is mounted rotatably by means of a bearing ring 121 projecting radially outward on the cylindrical outer surface area of the cylinder drum.

The axial rolling bearing 73, inclined correspondingly to the swashplate 74, likewise projects into the bearing bore 76 and is centered in the latter. The motor 32 is fastened to a backside of the swashplate 74 which faces away from the bearing bore 76.

At the end opposite the swashplate 74, the bearing bore 76 is closed by a control plate 77 connected fixedly to the pump housing 75.

In the pistons 71, pot-like coaxial bores 78 are formed, which extend outward toward the bottoms 70 of the pump cylinders 69 and in which prestressed helical compression springs 79 are arranged.

The helical compression springs 79 are supported at their one ends on the bottoms of the pump cylinders 69 and thus act upon the cylinder drum 68 against the control plate 77.

The helical compression springs 79 act with their other ends upon the bottoms of the coaxial bores 78 and thus hold the pistons 71 with their sliding shoes 72 in bearing contact against the second axial bearing 73.

On that end face of the cylinder drum 68 which is on the control-plate side, in the radially outer region of said cylinder drum, a radially continuous groove 80 is formed, in which is inserted an axial rolling bearing 81 via which the cylinder drum 68 is supported axially on the control plate 77.

Suction/delivery bores 82 formed parallel to the axis of rotation 67 in the cylinder drum 68 lead from the bottoms 70 of the pump cylinders 69 to the control plate 77. In this case, the suction/delivery bores 82 are arranged so as to be offset with respect to the center axis of the pump cylinder 69 radially in relation to the axis of rotation 67 of the cylinder drum 68.

In that end face of the control plate 77 which faces the cylinder drum 68, a kidney-shaped delivery port 83 and a kidney-shaped suction port 84 are formed, which extend concentrically with respect to the axis of rotation 67. These ports overlap those issues of the suction/delivery bores 82 which are on the control-plate side during the rotational movement of the cylinder drum 68.

A delivery connection 85 is connected to the kidney-shaped delivery port 83 and a suction connection 86 is connected to the kidney-shaped suction port 84, said connections being formed in the control plate 77.

Furthermore, in that end face of the control plate 77 which faces the cylinder drum 68, concentric relief grooves are formed. A first annular relief groove 87 is arranged radially outside the kidney-shaped delivery port 83 and kidney-shaped suction port 84 and a second relief groove 88 is arranged radially inside the kidney-shaped delivery port 83 and the kidney-shaped suction port 84.

The relief groove 88 in this case extends radially inward as far as the axis of rotation 67.

A third annular relief groove 89 is arranged in the control plate 77 in the region of the second axial rolling bearing 73.

Discharge ducts 90 formed in the control plate 77 lead from the relief grooves 87, 88 and 89 to a reservoir, not illustrated.

The sum of the cross-sectional areas 91 of the pump cylinders 69 located in each case above the kidney-shaped delivery port 83, minus the sum of the cross-sectional areas 92 of the suction/delivery bores 82 of these pump cylinders 69, is in the ratio of 2.06:1 to that area of the kidney-shaped delivery port 83 which faces the cylinder drum 68.

A position bore 93 is arranged parallel to the axis of rotation 67 in such a way that it extends from one part in the pump housing 75 and the other part in the swashplate 74. A tenon of equal diameter is inserted into the position bore 93 and forms a positioning element 94, by means of which the swashplate 74 and pump housing 75 are connected fixedly in terms of rotation and in a specific assignment to one another.

At the end facing the swashplate 74, the cylinder drum 68 possesses an axially projecting coaxial tenon 95 which is connected fixedly in terms of rotation to the drive shaft 33 of the motor 32 via an intermediate piece 96 of a slotted coupling 97.

The intermediate piece 96 has a strip 98 and 99 at each of its two ends, these strips extending, offset at 90° to one another, transversely with respect to the axis of rotation 67. The strip 98 engages in a corresponding groove 100, extending transversely with respect to the axis of rotation 67, of the drive shaft 33, and the strip 99 engages in a corresponding groove 101, extending transversely with respect to the axis of rotation 67, of the coaxial tenon 95.

FIGS. 18 to 21 illustrate further exemplary embodiments of pistons.

FIG. 18 shows a one-part piston 71′, of which the end 102 bearing against the axial rolling bearing is of hemispherical design and which is provided with a coaxial bore 78.

FIG. 19 shows a piston 71″ composed of three parts. In this case, a hemispherical supporting part 104 is arranged fixedly on one end face of a cylinder ring 103 and a coaxial tubular part 105 of smaller diameter than the diameter of the cylinder ring 103 is arranged fixedly on the other end face.

FIG. 20 shows a two-part piston 71′″ which consists of a cylinder ring 103′ and of a hemispherical supporting part 104′ fixedly arranged coaxially on the latter.

The piston 71″″ illustrated in FIG. 21 corresponds to the piston 71′″ from FIG. 20, that end region 106 of the cylinder ring 103′ which is opposite the supporting part 104′ possessing a smaller diameter than the cylinder ring 103′ at least over the length corresponding to the piston stroke of the pump.

FIG. 22 shows a further exemplary embodiment of the region of the swashplate 74′.

In this case, in a reversal with respect to the slotted coupling 97 of the exemplary embodiment of FIGS. 11 to 17, the strips 38′ and 39′ are arranged on the drive shaft 33′ and the coaxial tenon 95′ and the grooves 100′ and 101′ are arranged on the intermediate piece 96′.

The intermediate piece 96′ is provided at each of its two ends with a cylindrical widening 107 and 108, said cylindrical widenings being mounted rotatably via radial bearings 109 and 110 in corresponding recesses 111 and 112 of the swashplate 74′. The cylindrical widening 108 is additionally supported on the swashplate 74′ via a third axial bearing 113.

The shaft 114 connecting the cylindrical widenings 107 and 108 is surrounded by a shaft seal 116 inserted into a coaxial annular recess 115 of the swashplate 74′.

The exemplary embodiment of a swashplate-type axial piston pump, as illustrated in FIG. 23, corresponds largely to the exemplary embodiment illustrated in FIGS. 11 to 17.

The pistons are different. In FIG. 23, the pistons consist in each case of two balls 117 and 118 lined up with one another and having the same diameter as the pump cylinders 69, the balls 117 partially projecting out of the pump cylinder 69 and being in bearing contact against the second axial rolling bearing 73.

The helical compression springs 79 bear directly against the balls 118. FIGS. 24 to 26 show various examples of the arrangement of the second axial rolling bearing 73 on the swashplate 74.

The exemplary embodiment of FIG. 24 corresponds to the version in FIGS. 11 to 17.

In FIG. 25, a disk-like depression 119, into which the second axial rolling bearing 73 is inserted, is formed on that end face of the swashplate 74 which faces the cylinder drum 68.

In FIG. 26, a projecting cylindrical appendage 120, which carries the second axial rolling bearing 73, is arranged on that end face of the swashplate 74 which faces the cylinder drum 68.

List of reference symbols

| | |
|---|---|
| 1 | Cylinder |
| 1′ | Cylinder |
| 2 | Piston |
| 2′ | Piston |
| 3 | Annular groove |
| 4 | Sealing ring |
| 5 | Inner wall |
| 6 | First chamber |
| 7 | Second chamber |
| 8 | Bottom |
| 8′ | Bottom |
| 9 | Sealing and guide unit |
| 10 | Piston rod |
| 11 | First nonreturn valve |
| 12 | First connecting line |
| 13 | Second connecting line |
| 14 | Second nonreturn valve |
| 15 | Chamber part nearer the piston |
| 16 | Chamber part further from the piston |
| 17 | Pump |
| 17′ | Pump |
| 18 | First suction/delivery connection |
| 19 | Second suction/delivery connection |
| 20 | Annular chamber |
| 21 | Radial orifice |
| 22 | Booster piston |
| 23 | Piston side |
| 24 | Tappet |
| 25 | Annular groove |
| 26 | Sealing ring |
| 27 | Chamber part |
| 28 | Chamber part |
| 29 | Step |
| 30 | Pressure medium bypass line |
| 31 | Bypass groove |
| 32 | Motor |
| 32′ | Motor |
| 33 | Drive shaft |
| 34 | Seal |
| 35 | Housing |
| 36 | Seal |
| 37 | Connection |
| 38 | Seal |
| 39 | Shaft portion |
| 40 | Shaft portion |
| 41 | Magnetic coupling |
| 42 | Sealing wall |
| 43 | Connection |
| 44 | Wall |
| 45 | Coupling |
| 46 | Throttle |
| 47 | Connection |
| 48 | First nonreturn valve |
| 49 | Second connection |
| 50 | Releasable nonreturn valve |
| 51 | Throttle |
| 52 | Second nonreturn valve |
| 53 | Third connection |
| 54 | First pressure limiting valve |
| 55 | Second pressure limiting valve |
| 56 | Delivery connection |
| 57 | Fourth connection |
| 58 | Fifth connection |
| 59 | 1/2-way valve |
| 60 | Throttle |
| 61 | Suction connection |
| 62 | Sixth connection |
| 63 | Seventh connection |
| 64 | Third pressure limiting valve |
| 65 | Nonreturn valve |
| 66 | 2/2-way valve |
| 67 | Axis of rotation |
| 68 | Cylinder drum |
| 69 | Pump cylinder |
| 70 | Bottoms |
| 71 | Piston |
| 71′ | Piston |
| 71″ | Piston |
| 71′″ | Piston |
| 71″″ | Piston |
| 72 | Sliding shoe |
| 73 | Second axial rolling bearing |
| 74 | Swashplate |
| 74′ | Swashplate |
| 75 | Pump housing |
| 76 | Bearing bore |
| 77 | Control plate |
| 78 | Coaxial bores |
| 79 | Helical compression springs |
| 80 | Groove |
| 81 | Axial rolling bearing |
| 82 | Suction/delivery bores |
| 83 | Kidney-shaped delivery port |
| 84 | Kidney-shaped suction port |
| 85 | Delivery connection |
| 86 | Suction connection |
| 87 | Relief groove |
| 88 | Relief groove |
| 89 | Relief groove |
| 90 | Discharge ducts |
| 91 | Cross-sectional area |
| 92 | Cross-sectional area |
| 93 | Positioning bore |
| 94 | Positioning element |
| 95 | Coaxial tenon |
| 95′ | Coaxial tenon |
| 96 | Intermediate piece |
| 96′ | Intermediate piece |
| 97 | Slotted coupling |
| 98 | Strip |
| 99 | Strip |
| 99′ | Strip |
| 100 | Groove |
| 100′ | Groove |
| 101 | Groove |
| 101′ | Groove |
| 102 | End |
| 103 | Cylinder ring |
| 103′ | Cylinder ring |
| 104 | Supporting part |
| 104′ | Supporting part |
| 105 | Tubular part |
| 106 | End region |
| 107 | Cylindrical widening |
| 108 | Cylindrical widening |
| 109 | Radial bearing |
| 110 | Radial bearing |
| 111 | Recess |
| 112 | Recess |
| 113 | Third axial bearing |
| 114 | Shaft |
| 115 | Annular recess |
| 116 | Shaft seal |
| 117 | Ball |
| 118 | Ball |
| 119 | Depression |
| 120 | Appendage |
| 121 | Bearing ring |
| F | Push-out force |
| s | Travel |
| x | Active travel |

1.-70. (canceled)

71. A fluid linear drive comprising:
a cylinder which is at least partially filled with a pressure medium;
a piston dividing the cylinder into a first chamber and a second chamber, the first chamber having a bottom remote from the piston;
a piston rod extending through the second chamber and guided sealingly out of the cylinder;
an accumulator space; and
a pump having a first connection and a second connection, each connection for at least one of suction and delivery of the pressure medium, the first connection being connected to the first chamber, the second connection being connected to the accumulator space, the pump being arranged in the piston or at the bottom of the first chamber.

72. The fluid linear drive of claim 71 wherein the second chamber includes the accumulator space.

73. The fluid linear drive of claim 71 wherein the pressure medium comprises a hydraulic fluid.

74. The fluid linear drive of claim 71 wherein the pressure medium comprises a gas.

75. The fluid linear drive of claim 71 wherein the second chamber comprises a part near the piston containing a hydraulic fluid, and a part remote from the piston containing a gas and forming a volume compensation space.

76. The fluid linear drive of claim 75 further comprising a movable wall separating the part near the piston and the part remote from the piston.

77. The fluid linear drive of claim 71 further comprising an accumulator chamber that is separate from the first and second chamber, the accumulator chamber including the accumulator space.

78. The fluid linear drive of claim 77 wherein the accumulator chamber is an annular chamber surrounding the cylinder.

79. The fluid linear drive of claim 78 wherein the annular chamber is connected to the second chamber at an end of the cylinder opposing the bottom.

80. The fluid linear drive of claim 78 further comprising a movable wall separating the annular chamber into a first part defining the accumulator space and a second part defining a volume compensating space.

81. The fluid linear drive of claim 71 further comprising a first nonreturn valve which permits pressure medium to flow from the first chamber to the second chamber.

82. The fluid linear drive of claim 81 further comprising a second nonreturn valve which permits pressure medium to flow from the second chamber to the first chamber.

83. The fluid linear drive of claim 82 wherein at least one of the nonreturn valves is arranged in the piston.

84. The fluid linear drive of claim 71 wherein the pump is arranged at the bottom of the first chamber, the linear drive further comprising a booster piston arranged so that pressure medium discharged by the pump acts on the booster piston in order to increase force acting on the piston rod.

85. The fluid linear drive of claim 84 wherein the booster piston is arranged in the first chamber and has a piston area larger than the piston.

86. The fluid linear drive of claim 84 further comprising a tappet between the booster piston and the piston, the tappet being fixed to one of the piston and the booster piston and bearing against the other of the piston and the booster piston when the piston rod is retracted into the cylinder.

87. The fluid linear drive of claim 84 wherein the cylinder comprises a pressure medium bypass line which permits pressure medium in the first chamber to bypass the booster piston.

88. The fluid linear drive of claim 87 wherein the pressure medium bypass line comprises at least one groove in an inner wall of the first chamber.

89. The fluid linear drive of claim 71 wherein the pump is arranged at the bottom of the first chamber and is connected to a motor arranged outside of the cylinder by a drive shaft passing through a seal.

90. The fluid linear drive of claim 89 further comprising a coupling in the drive shaft.

91. The fluid linear drive of claim 90 wherein the coupling is a contactless magnetic coupling, a gearwheel coupling, or a toothed-belt coupling.

92. The fluid linear drive of claim 89 wherein the drive shaft comprises a flexible drive shaft.

93. The fluid linear drive of claim 89 wherein the motor is located in a housing which is sealed off with respect to the cylinder and comprises a housing pressure medium comprising at least one of a gas and an oil.

94. The fluid linear drive of claim 71 further comprising a throttle and a nonreturn valve arranged in at least one of the first and second connections and shutting off backflow from one of the first and second chamber.

95. The fluid linear drive of claim 71 further comprising a pressure limiting valve in a connection between the first and second chambers.
